(19) United States
(12) Patent Application Publication
(10) Pub. No.: US 2025/0136875 A1
(43) Pub. Date: May 1, 2025

(54) Artificial Intelligence based Demulsifier Control for Gas Oil Separation Plants with Electrostatic Coalescers

(71) Applicant: Saudi Arabian Oil Company, Dhahran (SA)

(72) Inventor: Ramsey James White, Abqaiq (SA)

(21) Appl. No.: 18/498,790

(22) Filed: Oct. 31, 2023

(51) Int. Cl. C10G 33/08; G05B 13/02

(52) U.S. Cl. CPC C10G 33/08; G05B 13/0265; C10G 2300/1059

(57) ABSTRACT

A computer implemented method that enables artificial intelligence based demulsifier control for AC or modulated AC/DC electrostatic coalescers is described. The method includes monitoring parameters associated with the GOSP facility and inputting the parameters to a trained machine learning model that outputs a minimum HPPT separation efficiency. The method includes determining a target HPPT separation efficiency based on the minimum HPPT separation efficiency. Additionally, the method includes adjusting a demulsifier dosage being injected into the HPPT apparatus to separate dry oil at the target HPPT separation efficiency.

### TECHNICAL FIELD

This disclosure generally relates to control processes and apparatus in a Gas Oil Separation Plant (GOSP).

### BACKGROUND

A Gas-Oil Separation Plant (GOSP) can separate water from crude oil to produce dry crude. The GOSP can achieve such separation by injecting demulsifier to separate free water using gravity separators then by using electrostatic coalescers for removing emulsified water and crude.

### BRIEF DESCRIPTION OF DRAWINGS

FIG. 1 shows an example of a Smart Demulsifier Control (SDC) architecture, according to an implementation.

FIG. 2 shows an example of an Artificial Intelligence based Smart Demulsifier Control (SDC) architecture, according to an implementation.

FIG. 3 is a process flow diagram of a process that enables artificial intelligence based demulsifier control for electrostatic coalescers.

FIG. 4 illustrates hydrocarbon production operations that include both one or more field operations and one or more computational operations, which exchange information and control exploration for the production of hydrocarbons.

FIG. 5 is a schematic illustration of an example controller (or control system) for that enables artificial intelligence based demulsifier control for electrostatic coalescers.

Like reference numbers and designations in the various drawings indicate like elements.

### DETAILED DESCRIPTION

Artificial intelligence based smart demulsifier control of electrostatic coalescer based systems is described. In embodiments, the disclosed technology is directed to a Gas-Oil Separation Plant (GOSP) facility with artificial intelligence based control. One of the primary functions of the GOSP facility is to separate water from crude oil to produce dry crude. This is achieved by separating free water using gravity separators (e.g., 3-Phase Separators also known as Production Traps) then by using electrostatic coalescers (e.g., Dehydrators and Desalters) for removing emulsified water and crude. In order to adjust the separation balance, demulsifier chemical is added to the production header. Demulsifier is a chemical that promotes water separation from the oil. The required amount of demulsifier in a GOSP facility depends upon a number of factors such as crude type, emulsion characterization, vessels design and chemical formulation effectiveness. In some cases, electrostatic coalescers use electric field to promote water separation from oil. In these cases, a particular amount of demulsifier can be introduced in the system to prevent upsets associated to the formation of rag layers around the interface of these separators. For example, using a 3-Phase separator, the separation facility can be equipped with a conventional AC electrostatic coalescer that provides the voltage and other measurements for each transformer as feedback signals to the control system.

Process upsets in the Dehydrator, which are caused by contact of the electrostatic coalescer grids to a chain of emulsion droplets between the grids and the vessel/ground, occasionally occur. When this happens, a de-energization is detected in the grid's voltage. For conventional AC electrostatic coalescers, no monitoring signals are available for Operations to check the operational condition on the water/oil layer in a proactive manner unless an interface level profiler is used. As a result, all operational controls are based on operating procedures as to conduct skimming operations in regular basis and maintain enough demulsifier in the system to ensure steady operation.

The present systems and techniques incorporate artificial intelligence based demulsifier control for modulated AC/DC electrostatic coalescers that using electric voltage or current readings associated with the modulated AC/DC electrostatic coalescer technology as it strongly correlates to water-oil interface layer quality. By way of background, recent progress in electrostatic coalesce technologies may improve (or maximize) water separation from crude. One of these technologies is based on the utilization not only of AC fields but also the DC field. This technology is called modulated AC/DC electrostatic coalescer). Under the modulated AC/DC electrostatic coalescer technology, the feedback signals enable internal control action and therefore these feedback signals are provided to the local modulated AC/DC electrostatic coalescer control panel which is communicated with Distributed Control System (DCS). Leveraging the electric voltage and current readings associated with the modulated AC/DC electrostatic coalescer technology, implementations of the present disclosure can pursue a modulated AC/DC electrostatic coalescer monitoring logic to determine the optimum dosage based on current and voltages of all the modulated AC/DC electrostatic coalescer transformers as well as other parameters. Some cases allow switching off the HPPT separation (e.g., the 3-phase separator) monitor for cases of low separation. In these cases, the modulated AC/DC electrostatic coalescer Dehydrator alone will be the demulsifier driver if the HPPT apparatus is not separating sufficiently enough. Additionally, optimum dosage based on modulated AC/DC electrostatic coalescer monitoring is related to the overall demulsifier limits (including the minimum and maximum concentration limits). Therefore, the optimum demulsifier dosage will also depend on the current trends and the overall process temperature.

In some embodiments, GOSP inputs such as injection water rate, wash water rate, HPPT rater rate, dehydrator transformer voltage(s) or current(s), dry crude rate, HPPT oil or gas temperature, and other variables are input to an AI model (e.g., AI Generated Algorithm). The AI model outputs an optimum separation efficiency which is the set point. A demulsifier dosage being injected into an HPPT apparatus is adjusted according to the HPPT separation setpoint, wherein the adjustment is below a high output limit derived from the dehydrator voltage. If the “AI Developed Model” is disabled, the system will return to the calculated target separation efficiency.

In some implementations, a typical GOSP can include equipment identified in Table 1:

TABLE 1
Typical GOSP Equipment
GOSP Equipment

| Equipment | Description |
|---|---|
| HPPT | The HPPT separates gas at high pressure (for example, 150-450 psig) from |
| | the crude oil. It can operate as a three-phase separator to separate free |
| | water also. |
| Demulsifier | This demulsifier injection skid injects demulsifier chemical at the |
| Injection Skid | production header. Demulsifier breaks emulsions to allow for separation |
| | of free water in the high-pressure production trap and assist in crude |
| | desalting. |
| LPPT | The low pressure production trap (LPPT) separates gas at low pressure (for |
| | example, 50 psig) from the crude oil. |
| Charge Pumps | The charge pumps pressure the crude oil from the LPPT to discharge into |
| | the crude oil desalting train. |
| Dehydrator | The dehydrator, which receives crude from the charge pumps, is the first |
| | stage electrostatic coalescer of the desalting train to remove the bulk |
| | emulsions from the crude oil under an electrostatic field. |
| Mixing Valve | The mixing valve station shears injection wash water to mix with residual |
| Station | produced water. This will bring the average salinity of the water in the oil. |
| Desalter | The desalter is the second-stage electrostatic coalescer of the desalting |
| | train. It removes the remaining produced water along with injected wash |
| | water to produce dry and desalted crude (at 0.2% BS&W and 10 PTB) |
| WOSEP | The water-oil separator (WOSEP) de-oils the produced water from the |
| | HPPT, dehydrator and desalter to less than 100 milligrams per liter |
| Disposal Water | The disposal water injection pumps discharge water into disposal wells for |
| Injection Pumps | maintaining reservoir pressure |

The following terms apply to the present disclosure. A “demulsifier concentration” is a measurement of concentration, typically in parts per million (ppm), of demulsifier chemical in the total fluid, such as a fluid including oil and water. An “HPPT separation efficiency” is a percentage of water separated in the HPPT versus the total water removed at the GOSP. An “HPPT retention time” is a time, in minutes, for water to separate from crude in an HPPT separation compartment, such as an upstream water weir.

In examples, a configuration of the GOSP is used to determine the best possible control scheme for the GOSP based on, for example, the number of production manifolds, HPPTs, line-up options between manifolds and HPPTs, and mode of operation of each HPPT, such as whether the mode is three-phase or 2-phase. A demulsifier is normally added upstream of the HPPT through an automatic flow control.

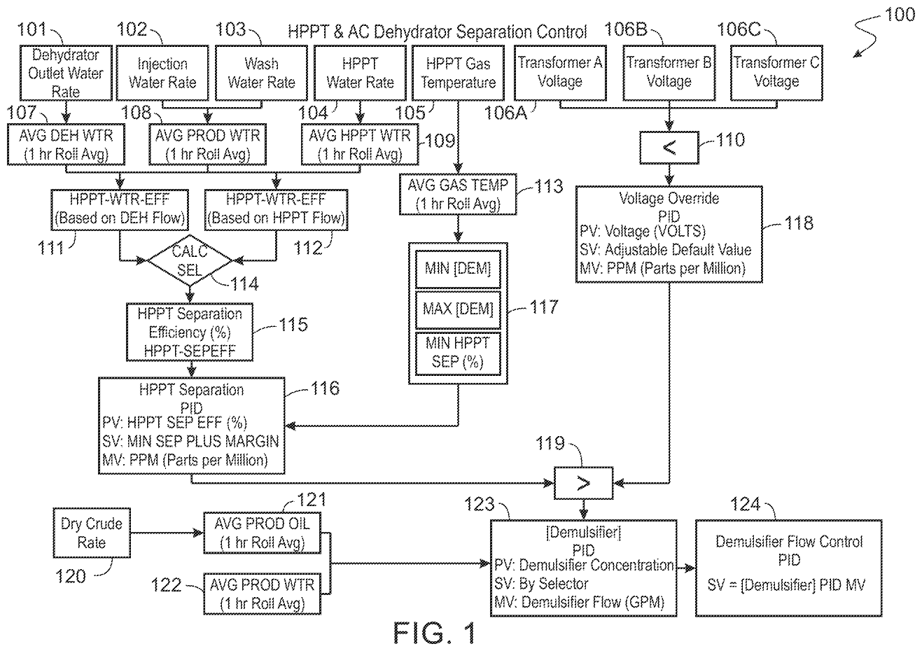

FIG. 1 shows an example of a Smart Demulsifier Control (SDC) architecture 100, according to an implementation. In particular, the architecture 100 illustrates adjusting demulsifier injection rates to control high-pressure production trap (HPPT) separation efficiency based on, for example, AC dehydrator/desalter control. Components in the SDC architecture 100 include the following annotations. A flow indication (FI) can indicate, for example, a flow reading from flow transmitter. A temperature indication (TI) can indicate, for example, a temperature reading from temperature transmitter. A process value (PV) can indicate, for example, a value of a process variable that is being controlled. A manipulated value (MV) can indicate, for example, a controller output that triggers action of a final control element to a control process variable. A set value (SV) can indicate, for example, a desired set point of the process variable that is being controlled. The SDC architecture 100 also identifies one or more instances of a flow indication controller, a proportional integral derivative (PID) control, an hourly average (HAV), and a GOSP.

As illustrated, dehydrator outlet water rate 101 is analyzed to generate average dehydrator water rate 107. In one example, the average dehydrator water rate is represented by a rolling average on a 1-hour basis (107). Injection water rate (102) and wash water rate (103) are combined to generate average production water rate (108). In one example, the average produced water rate is a rolling average on a 1-hour basis. HPPT water rate 104 can lead to a rolling average of the water flow rate from the HPPT (109). The rolling average can be on an hourly basis. Dehydrator water rate 107, average produced water rate 108, average HPPT water rate 109 can lead to a first HPPT water efficiency 111 that is based on dehydrator water rate and a second HPPT water efficiency 112 that is based on HPPT water rate.

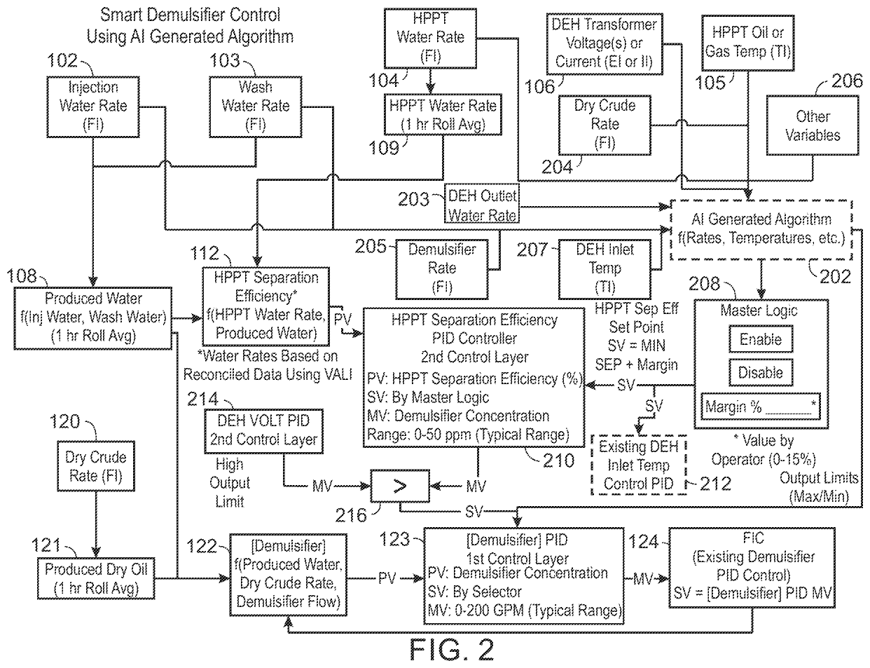

The SDC architecture 100 may calculate a selection (114) of one of the two HPPT water efficiency numbers to determine, using AI algorithms, a HPPT separation efficiency 115. In the meantime, HPPT gas temperature 105 is provided to generate an average gas temperature 113, for example, as a rolling average on an hourly basis. The average gas temperature (113) can drive the selection of a minimum demulsifier concentration, a maximum demulsifier concentration, and a minimum HPPT separation efficiency (117). A minimum demulsifier concentration is a minimum allowed demulsifier concentration as a function of the temperature. The concentration can provide the dynamic low output limit for PID control of HPPT separation efficiency. A maximum demulsifier concentration is a maximum allowed demulsifier concentration as a function of the temperature. The concentration provides the dynamic high output limit for PID controllers of HPPT separation efficiency and for the dehydrator voltage override. A minimum HPPT separation efficiency is a minimum separation expected at HPPT as a function of the temperature. In examples, minimum separation efficiency is determined, at least in part, using artificial intelligence algorithms as described with respect to FIG. 2. Minimum separation efficiency is determined using a trained model that dynamically optimizes separation efficiency and sends as an output to the HPPT separation efficiency controller.

A target separation efficiency is identified that is between the minimum target separation efficiency and the maximum target separation efficiency. As an example, the HPPT separation efficiency PID controller 116 can determine the target separation efficiency using the minimum and maximum target separation efficiencies. The HPPT separation efficiency PID controller 116 can control the separation of water from oil in an HPPT, such as with an “HPPT Separation Efficiency (%).” Voltage 106A from transformer A, voltage 106B from transformer B, voltage 106C from transformer C are provided to a low value calculation (110) and then used in a voltage override PID controller 118. The output of the HPPT separation efficiency PID controller 116 and the output of voltage override PID controller 118 can be used in a high value calculation (119) for the set point of the demulsifier concentration PID controller 123. The demulsifier concentration can be increased if the separation efficiency is lower than the set point. It can be decreased if separation efficiency is greater than the set point. Demulsifier concentration limits, including maximum and minimum, can be determined based on site-specific AI algorithms.

A dry crude rate 120 can indicate a total produced oil rate from the GOSP. The dry crude rate 120 can be used to generate a one-hour rolling average produced dry oil 121. Average produced dry oil 121 and average produced water 122, both in hourly average, can feed the demulsifier PID controller 123, which has received the set point from the high value calculation 119. Notably, average produced water 122 and average production water rate 108 can form one stream of data. The demulsifier PID controller 123 can drive a demulsifier flow controller PID 124 that provides a demulsifier flow control loop. The flow can be automatically adjusted based on a flow set point of a demulsifier PID controller 123. Output of the demulsifier concentration PID controller 123 is the set point of the demulsifier flow controller PID 124.

The example from FIG. 1 incorporate feedback signals from conventional AC electrostatic coalescers which traditionally provide voltage measurements for each transformer. Process Upsets in the Dehydrator/Desalter, which are caused by contact of the electrostatic grid to a chain of emulsion droplets between the energized grids and the vessel/ground, do occur. As discussed above, for conventional AC electrostatic coalescers, no monitoring signals are available for Operations to check the operational condition on the water/oil in a proactive manner. As a result, all operational controls are based on operating procedures as to conduct skimming operations in regular basis and maintain enough demulsifier in the system to ensure steady operation. Electrostatic coalescer interface quality measurement can also be measured using profilers. Two types of technologies may be used: nuclear and capacitance based technologies. By way of illustration, a nuclear based approach may involve the use of radiative materials.

Recent advances in electrostatic coalescer technology have opened the feasibility of providing more information to the control system which monitors the operational status of each transformer. For illustration, the transformer notches the voltage up to operator settings to create the electromagnetic fields needed to polarize the water droplets. Electricity is channeled through the transformers to the plates (or grids) through the bushings of the transformer. Based on the observation of dynamic behavior of the transformers current reading, some implementations incorporate a control algorithm which uses the rate of change of the transformers current signals as a controlled variable to adjust the demulsifier concentration in the production header. When an emulsion layer starts to grow on the electrostatic coalescer oil-water interface, a current consumption increase is measured. This current increase can be detected before the upset de-energizes the grids, thereby improving the chemical consumption and increasing the maximum potential benefit of the upgraded dehydration technology.

The present techniques incorporate one or more artificial intelligence models to predict minimum separation efficiencies and temperature controller set points to avoid a process upset in real time. Algorithms that can be used include regression, neural networks, decision trees and other AI algorithms. Separation from the HPPT and inlet dehydrator temperature that will result in the lowest cost, energy consumption and/or carbon emission are determined.

The AI models eliminate excessive human intervention to determine the required demulsifier addition rate. Iterative updates of target separation models in current control scheme ensures optimized demulsifier control in real time. Further, the present techniques optimize chemical and energy consumption used for breaking emulsion. The present techniques use more than simple operating procedures to ensure chemical usage optimization in a continuous mode. Accordingly, the AI algorithms prevent process upsets at the dehydrator by adjustment of demulsifier. In particular, incorporating the described control scheme will better utilize the data available in the system to proactively adjust demulsifier dosage and energy consumption to prevent upsets (i.e., enhancing crude quality) and optimizing chemical consumption.

FIG. 2 shows an example of an Artificial Intelligence based Smart Demulsifier Control (SDC) architecture 200, according to an implementation. In examples, the architecture 200 includes the architecture 100 of FIG. 1. As illustrated, the SDC architecture 200 includes AI generated algorithms 202. Trained AI algorithms are used to determine the minimum HPPT separation efficiency to avoid a process upset in real time. This is because the minimum HPPT separation efficiency is dynamic and changes depending on the season (winter vs summer), well line-up and other factors. In examples, well line-up refers to the status of wells (opened/closed) at any time. Some wells may cause upsets if opened and producing crude and emulsions to an oil facility, requiring a higher target separation. Static models are updated manually, while the dynamic AI generated models according to the present techniques will update the model automatically using machine learning. Additionally, other factors used by the artificial intelligence models to set the minimum HPPT separation efficiency include, for example: (i) Dehydrator/electrostatic coalescer Upsets (avoid conditions that lead to dehydrator voltage to dip): (ii) Crude Quality (avoid water-in-oil in dry crude product from exceeding specification: (iii) Vessel Level Profiler in HPPT/3-Phase Separator and Dehydrator (contain emulsion layer and avoid excess emulsion from reaching critical level that causes upset in the dehydrator); and (iv) Ability of Wet/Dry Crude Heat Exchangers to control Dehydrator Inlet Temperature (avoid excess water with crude so that available waste heat can maintain minimum inlet temperature into dehydrator). Algorithms that can be used include regression, neural networks, decision trees and other AI algorithms. The architecture 200 optimizes the separation from the HPPT and inlet dehydrator temperature that will result in the lowest cost, energy consumption and/or carbon emission.

In examples, the AI generated algorithms 202 are a function of oil and gas rates, temperatures, and the like. AI models are generated according to the available data to predict target separation target separation efficiencies and temperature controller set points to avoid a process upset in real time. In examples, the available data varies based on a configuration of the GOSP. In this manner, the present techniques incorporate measurements available from a particular GOSP and adjust the upstream demulsifier injection to ensure the crude desalting process is more efficient and less prone to upsets from a build-up of crude oil emulsions caused by a lack of demulsifier injection.

Real-time process data is gathered from various sensors and instruments installed throughout the gas-oil separation plant. This data includes parameters such as flow rates, temperatures, pressures, levels, dehydrator voltage, dehydrator current, and other relevant variables. For example, parameters including an injection water rate (102) and wash water rate (103), dehydrator voltage/current (106), HPPT oil or gas temperature (105), dry crude rate (204), demulsifier rate (205), other variables (206), and dehydrator inlet temperature (207) are obtained as inputs to AI generated algorithms 202. The gathered data is processed to ensure its quality, consistency, and compatibility with the AI algorithm. This may involve cleaning the data, handling missing values, normalizing the data, and addressing any outliers or noise. For ease of illustration, particular input variables to the AI generated algorithms 202 are shown in FIG. 2. However, any data associated with a GOSP can be used as inputs to the AI generated algorithms. In examples, the AI generated algorithms 202 can use the HPPT/3-Phase Separator outlet rate 104 or the dehydrator Outlet water rate 203 to calculate the maximum separation efficiency. Both values can be used as it is a mass balance (any water not separation in the HPPT(s) is separated in the dehydrator.

The AI generated algorithms 202 then integrate the various data sets to create a comprehensive view of the GOSP process. Correlation analysis is applied to identify relationships, dependencies, patterns, etc. between different process variables. The AI algorithm applies machine learning techniques to train models based on the gathered data, identified correlations and the known outcomes. A model that can predict target separation target separation efficiencies and temperature controller set points in generated by the AI algorithm. These models can be based on various algorithms, such as regression, neural networks, decision trees and others. Models are continuously evaluated using validation datasets to assess their performance and accuracy. The algorithm iteratively refines and optimizes the models by adjusting parameters, selecting relevant features, or applying ensemble methods to improve predictions. Once the models are trained and validated, the AI algorithm can be applied in real-time to continuously monitor the process data from the gas-oil separation plant. It uses the trained models to predict the required separation efficiencies and temperature controller set points based on the current process conditions. The AI algorithm continuously updates and refines its models based on new data and feedback from the actual performance of the plant. This feedback loop allows the algorithm to adapt and improve its predictions over time, leading to better separation efficiencies and optimized temperature control.

The architecture 200 includes two control layers, a first control layer responsive to manual controls and a second control layer controlled by AI generated algorithms. The AI enabled second control layer is used for demulsifier control, unless the second control scheme is unable to perform its function, such as when one of the base controllers (e.g. demulsifier control loops) or measurements (e.g. water flow leaving the facility) malfunctions. A first control layer includes the demulsifier concentration controller 123. The Demulsifier PID controller, or Demulsifier Concentration Controller 123, adjusts the demulsifier concentration (PV or Process Value) to the set point (SV) specified by the second control layer. As an example, if the setpoint increases, it will increase the demulsifier rate (GPD or Gallons per Day) to achieve the desired concentration. If the oil and water production rate increases, it will also increase the demulsifier rate to achieve the setpoint demulsifier concentration. PID stands for Proportional-Integral-Derivative, which are the three parameters of a controller. MV or manipulated value is the output of the controller, which is the Gallons Per Day flow setpoint of the demulsifier injection pump flow controller. The second layer controller is a master logic 208 that controls the separation efficiency of the High Pressure Production Trap (HPPT) or the 3-phase separator via the HPPT separation efficiency PID controller 210. The measured efficiency (which is calculated based on water separated from the HPPT divided by total plant water, or total plant water minus water separated from the dehydrator divided by total plant water) is compared it to the target separation efficiency or the setpoint (SV). As an example, if the actual separation (PV) is higher than the setpoint, it will specify a lower demulsifier concentration as an output (MV) to the [Demulsifier] PID 123 or 1^{st} layer controller.

In the example of FIG. 2, the master logic 208 outputs set variables to the HPPT separation efficiency PID controller 210 and existing dehydrator inlet temperature control PID 212. In some examples, the temperature control PID 212 is associated with a preheater to the dehydrator. For example, the controller maintains the crude temperature to its optimum temperature for adequate crude dehydration. It has to be at its sweet spot for reducing viscosity to enhance separation of water droplets. Too high of a temperature causes risks of gas generation in the dehydrator and excess energy consumption. Too low of a temperature impacts oil-water separation. The master logic 208 enables selection between control layers of the architecture 200. The master logic determines the source of the minimum separation efficiency. For example, the second control layer can be enabled or disabled by operations at the master logic 208. When the second control layer is enabled at the master logic 208, the second control layer controls the separation efficiency. Additionally, Operations has the flexibility of adding a margin to the calculated optimum separation efficiency. When the master logic is disabled, operations set the desired demulsifier concentration manually.

HPPT Separation efficiency PID controller 210 obtains as input a process variable HPPT separation efficiency percentage and set variables from the master logic 208. In examples, the output of the HPPT separation efficiency PID controller 210 and the output of voltage override PID controller 214 can be used in a high value calculation (216) for the set point of the demulsifier concentration PID controller 123. The demulsifier concentration can be increased if the separation efficiency is lower than the set point. It can be decreased if separation efficiency is greater than the set point. Demulsifier concentration limits, including maximum and minimum, can be determined based AI generated models. As a safeguard, there is a separation dehydrator (DEH) control block that will increase the demulsifier rate to a desired maximum limit in case of an upset (low voltage) in the dehydrator.

In lieu of a static equation entered manually to calculate the target separation efficiency by the HPPT Separation efficiency PID controller 210, the HPPT Separation efficiency PID controller 210 uses AI generated algorithms 202 to continuously update the target separation. In particular, machine learning algorithms are used to continuously update the target separation based on actual process data. The calculated value is the set point (SV) of the HPPT Separation Efficiency PID controller.

In addition to optimizing the demulsifier dosage and achieving a target HPPT separation efficiency, the AI Generated Algorithm 202 will also specify the set point of the inlet temperature setpoint into the dehydrator (DEH) using the existing dehydrator inlet temperature control PID 212 to optimize the overall energy consumption. Steam consumption is also an input to the AI algorithm.

A dry crude rate 120 can indicate a total produced oil rate from the GOSP. The dry crude rate 120 can be used to generate a one-hour rolling average produced dry oil 121. Average produced dry oil 121 and average produced water 108, both in hourly average, can feed the demulsifier PID controller 123, which has received the set point from the high value calculation 216. The demulsifier PID controller 123 can drive a demulsifier flow controller PID 124 that provides a demulsifier flow control loop. The flow can be automatically adjusted based on a flow set point of a demulsifier PID controller 123. Output of the demulsifier concentration PID controller 123 is the set point of the demulsifier flow controller PID 124.

One advantage associated with this implementation is the ability to ensure crude quality in real time. For example, the demulsifier dosage is optimized in this process because it is not continuously over-injected to ensure that no upsets occur. Indeed, by determining target separation efficiencies by an artificial intelligence based function, which is more sensitive, demulsifier control is tuned to the variables associated with a particular GOSP.

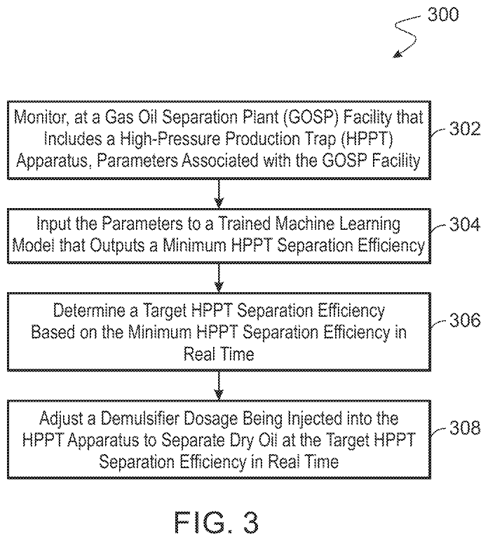

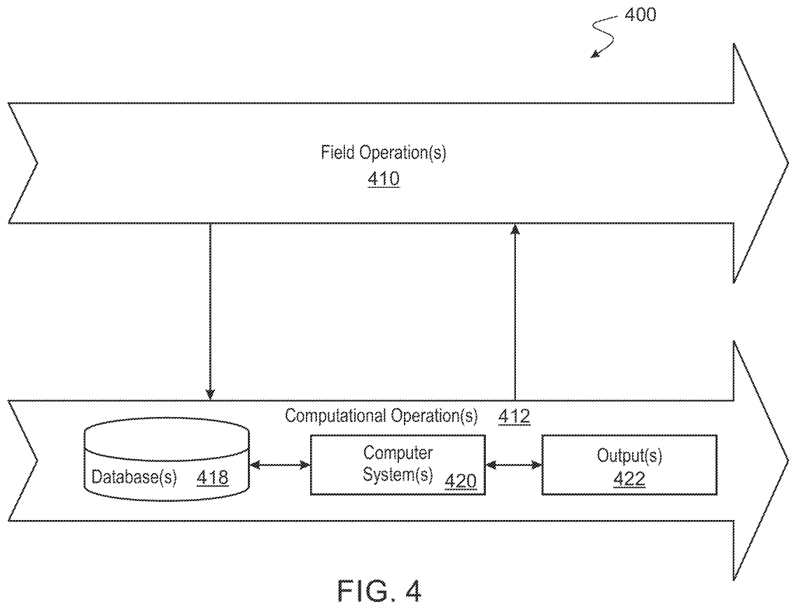

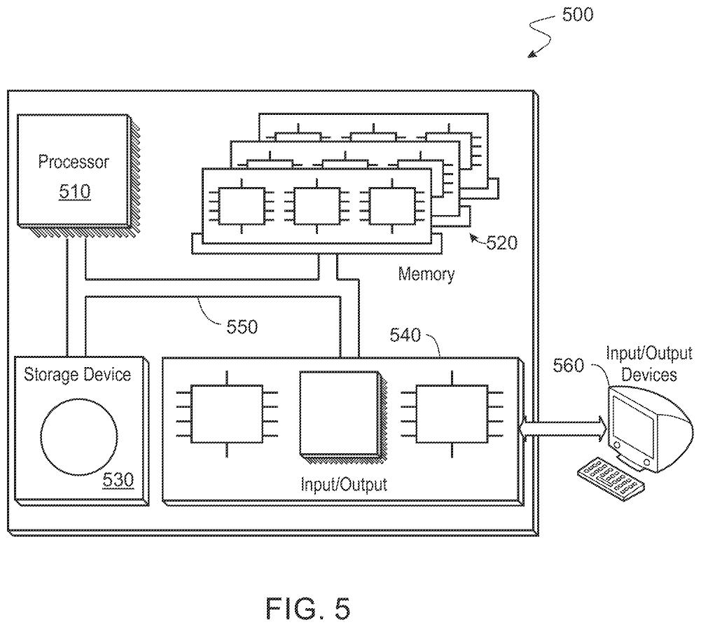

FIG. 3 is a process flow diagram of a process 300 that enables artificial intelligence based demulsifier control for electrostatic coalescers. In some embodiments, the process 300 is implemented in an architecture that this the same as or similar to architecture 100 of FIG. 1. In some embodiments, the process 300 is implemented in an architecture that this the same as or similar to architecture 200 of FIG. 2. In some embodiments, the process 300 is implemented in hydrocarbon production operations 400 of FIG. 4. In some embodiments, the process 300 is implemented controller 500 of FIG. 5.

At block 302, parameters are monitored at a gas oil separation plant (GOSP) facility that includes a high-pressure production trap (HPPT) apparatus. The parameters include at least a voltage or a current of a dehydrator transformer. In examples, the parameters comprise at least one of an injection water rate, a wash water rate, a dehydrator voltage, a dehydrator current, HPPT oil or gas temperature, dry crude rate, demulsifier rate, dehydrator outlet water rate, steam consumption, or a dehydrator inlet temperature. In examples, the dehydrator transformer is a component of a modulated AC/DC electrostatic coalescer device.

At block 304, the parameters are input to a trained machine learning model that outputs a minimum HPPT separation efficiency.

At block 306, a target HPPT separation efficiency is determined based on the minimum HPPT separation efficiency. In examples, the target HPPT separation efficiency is continuously updated in real time in response to real-time process data associated with the GOSP. Additionally, in examples, a set point of an inlet temperature of a dehydrator (DEH) is determined using an artificial intelligence generated algorithm to optimize the overall energy consumption.

At block 308, a demulsifier dosage being injected into the HPPT apparatus to separate dry oil at the target HPPT separation efficiency is adjusted. In examples, the demulsifier dosage is adjusted below a high output limit derived from a dehydrator voltage. Additionally, in some embodiments, adjusting the demulsifier dosage is based on a gas temperature indication at the HPPT apparatus.

FIG. 4 illustrates hydrocarbon production operations 400 that include both one or more field operations 410 and one or more computational operations 412, which exchange information and control exploration for the production of hydrocarbons. In some implementations, outputs of techniques of the present disclosure can be performed before, during, or in combination with the hydrocarbon production operations 400, specifically, for example, either as field operations 410 or computational operations 412, or both.

Examples of field operations 410 include forming/drilling a wellbore, hydraulic fracturing, producing through the wellbore, injecting fluids (such as water) through the wellbore, to name a few. In some implementations, methods of the present disclosure can trigger or control the field operations 410. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 410 and responsively triggering the field operations 410 including, for example, generating plans and signals that provide feedback to and control physical components of the field operations 410. Alternatively or in addition, the field operations 410 can trigger the methods of the present disclosure. For example, implementing physical components (including, for example, hardware, such as sensors) deployed in the field operations 410 can generate plans and signals that can be provided as input or feedback (or both) to the methods of the present disclosure.

Examples of computational operations 412 include one or more computer systems 420 that include one or more processors and computer-readable media (e.g., non-transitory computer-readable media) operatively coupled to the one or more processors to execute computer operations to perform the methods of the present disclosure. The computational operations 412 can be implemented using one or more databases 418, which store data received from the field operations 410 and/or generated internally within the computational operations 412 (e.g., by implementing the methods of the present disclosure) or both. For example, the one or more computer systems 420 process inputs from the field operations 410 to assess conditions in the physical world, the outputs of which are stored in the databases 418. For example, seismic sensors of the field operations 410 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 412 where they are stored in the databases 418 and analyzed by the one or more computer systems 420.

In some implementations, one or more outputs 422 generated by the one or more computer systems 420 can be provided as feedback/input to the field operations 410 (either as direct input or stored in the databases 418). The field operations 410 can use the feedback/input to control physical components used to perform the field operations 410 in the real world.

For example, the computational operations 412 can process the seismic data to generate three-dimensional (3D) maps of the subsurface formation. The computational operations 412 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 412 to process new information about the formation and control the drilling to adjust to the observed conditions in real-time.

The one or more computer systems 420 can update the 3D maps of the subsurface formation as information from one exploration well is received and the computational operations 412 can adjust the location of the next exploration well based on the updated 3D maps. Similarly, the data received from production operations can be used by the computational operations 412 to control components of the production operations. For example, production well and pipeline data can be analyzed to predict slugging in pipelines leading to a refinery and the computational operations 412 can control machine operated valves upstream of the refinery to reduce the likelihood of plant disruptions that run the risk of taking the plant offline.

In some implementations of the computational operations 412, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

FIG. 5 is a schematic illustration of an example controller 500 (or control system) for that enables artificial intelligence based demulsifier control for electrostatic coalescers. For example, the controller 500 may be operable according to the workflow 200 of FIG. 2 or the process 1110 of FIG. 11. In some embodiments, the controller 500 is the same as or similar to the computer systems 420 of FIG. 4. The controller 500 is intended to include various forms of digital computers, such as printed circuit boards (PCB), processors, digital circuitry, or otherwise parts of a system for supply chain alert management. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 500 includes a processor 510, a memory 520, a storage device 530, and an input/output interface 540 communicatively coupled with input/output devices 560 (for example, displays, keyboards, measurement devices, sensors, valves, pumps). Each of the components 510, 520, 530, and 540 are interconnected using a system bus 550. The processor 510 is capable of processing instructions for execution within the controller 500. The processor may be designed using any of a number of architectures. For example, the processor 510 may be a CISC (Complex Instruction Set Computers) processor, a RISC (Reduced Instruction Set Computer) processor, or a MISC (Minimal Instruction Set Computer) processor.

In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output interface 540.

The memory 520 stores information within the controller 500. In one implementation, the memory 520 is a computer-readable medium. In one implementation, the memory 520 is a volatile memory unit. In another implementation, the memory 520 is a nonvolatile memory unit.

The storage device 530 is capable of providing mass storage for the controller 500. In one implementation, the storage device 530 is a computer-readable medium. In various different implementations, the storage device 530 may be a floppy disk device, a hard disk device, an optical disk device, or a tape device.

The input/output interface 540 provides input/output operations for the controller 500. In one implementation, the input/output devices 560 includes a keyboard and/or pointing device. In another implementation, the input/output devices 560 includes a display unit for displaying graphical user interfaces.

There can be any number of controllers 500 associated with, or external to, a computer system containing controller 500, with each controller 500 communicating over a network. Further, the terms “client,” “user,” and other appropriate terminology can be used interchangeably, as appropriate, without departing from the scope of the present disclosure. Moreover, the present disclosure contemplates that many users can use one controller 500 and one user can use multiple controllers 500.

### EMBODIMENTS/EXAMPLES

According to some non-limiting embodiments or examples, provided is a computer-implemented method, comprising: monitoring, using at least one hardware processor, at a gas oil separation plant (GOSP) facility that includes a high-pressure production trap (HPPT) apparatus, parameters associated with the GOSP facility; inputting, using the at least one hardware processor, the parameters to a trained machine learning model that outputs a minimum HPPT separation efficiency; and determining, using the at least one hardware processor, a target HPPT separation efficiency based on the minimum HPPT separation efficiency; and adjusting, using the at least one hardware processor, a demulsifier dosage being injected into the HPPT apparatus to separate dry oil at the target HPPT separation efficiency.

According to some non-limiting embodiments or examples, provided is a system, comprising: at least one processor, and at least one non-transitory storage media storing instructions that, when executed by the at least one processor, cause the at least one processor to: monitor, at a gas oil separation plant (GOSP) facility that includes a high-pressure production trap (HPPT) apparatus, parameters associated with the GOSP facility: input the parameters to a trained machine learning model that outputs a minimum HPPT separation efficiency: determine a target HPPT separation efficiency based on the minimum HPPT separation efficiency; and adjust a demulsifier dosage being injected into the HPPT apparatus to separate dry oil at the target HPPT separation efficiency.

According to some non-limiting embodiments or examples, provided is a at least one non-transitory storage media storing instructions that, when executed by at least one processor, cause the at least one processor to: monitor, at a gas oil separation plant (GOSP) facility that includes a high-pressure production trap (HPPT) apparatus, parameters associated with the GOSP facility: input the parameters to a trained machine learning model that outputs a minimum HPPT separation efficiency; determine a target HPPT separation efficiency based on the minimum HPPT separation efficiency; and adjust a demulsifier dosage being injected into the HPPT apparatus to separate dry oil at the target HPPT separation efficiency.

Further non-limiting aspects or embodiments are set forth in the following numbered embodiments:

Embodiment 1: A computer-implemented method, comprising: monitoring, using at least one hardware processor, at a gas oil separation plant (GOSP) facility that includes a high-pressure production trap (HPPT) apparatus, parameters associated with the GOSP facility: inputting, using the at least one hardware processor, the parameters to a trained machine learning model that outputs a minimum HPPT separation efficiency: determining, using the at least one hardware processor, a target HPPT separation efficiency based on the minimum HPPT separation efficiency: adjusting, using the at least one hardware processor, a demulsifier dosage being injected into the HPPT apparatus to separate dry oil at the target HPPT separation efficiency.

Embodiment 2: The computer-implemented method of embodiment 1, wherein the parameters comprise at least one of an injection water rate, a wash water rate, a dehydrator voltage, a dehydrator current, HPPT oil or gas temperature, dry crude rate, demulsifier rate, dehydrator outlet water rate, steam consumption, or a dehydrator inlet temperature.

Embodiment 3: The computer-implemented method of embodiments 1 or 2, wherein the target HPPT separation efficiency is continuously updated in real time in response to real-time process data associated with the GOSP.

Embodiment 4: The computer-implemented method of embodiments 1-3, comprising determining a set point of an inlet temperature of a dehydrator using an artificial intelligence generated algorithm to optimize an overall energy consumption.

Embodiment 5: The computer-implemented method of embodiments 1, wherein dehydrator transformer is a component of an electrostatic coalescer or a modulated AC/DC electrostatic coalescer device.

Embodiment 6: The computer-implemented method of embodiments 1-5, wherein the demulsifier dosage is adjusted below a high output limit derived from a dehydrator voltage or current using artificial intelligence algorithms.

Embodiment 7: The computer-implemented method of embodiments 1-6, wherein adjusting the demulsifier dosage is based on a gas temperature indication at the HPPT apparatus using artificial intelligence algorithms.

Embodiment 8: A system, comprising: at least one processor, and at least one non-transitory storage media storing instructions that, when executed by the at least one processor, cause the at least one processor to: monitor, at a gas oil separation plant (GOSP) facility that includes a high-pressure production trap (HPPT) apparatus, parameters associated with the GOSP facility: input the parameters to a trained machine learning model that outputs a minimum HPPT separation efficiency; determine a target HPPT separation efficiency based on the minimum HPPT separation efficiency; and adjust a demulsifier dosage being injected into the HPPT apparatus to separate dry oil at the target HPPT separation efficiency.

Embodiment 9: The system of embodiment 8, wherein the parameters comprise at least one of an injection water rate, a wash water rate, a dehydrator voltage, a dehydrator current, HPPT oil or gas temperature, dry crude rate, demulsifier rate, dehydrator outlet water rate, steam consumption, or a dehydrator inlet temperature.

Embodiment 10: The system of embodiments 8-9, wherein the target HPPT separation efficiency is continuously updated in real time in response to real-time process data associated with the GOSP.

Embodiment 11: The system of embodiments 8-10, comprising determining a set point of an inlet temperature of a dehydrator using an artificial intelligence generated algorithm to optimize an overall energy consumption.

Embodiment 12: The system of embodiments 8-11, wherein dehydrator transformer is a component of an electrostatic coalescer or a modulated AC/DC electrostatic coalescer device.

Embodiment 13: The system of embodiments 8-12, wherein the demulsifier dosage is adjusted below a high output limit derived from a dehydrator voltage or current using artificial intelligence algorithms.

Embodiment 14: The system of embodiments 8-13, wherein adjusting the demulsifier dosage is based on a gas temperature indication at the HPPT apparatus using artificial intelligence algorithms.

Embodiment 15: At least one non-transitory storage media storing instructions that, when executed by at least one processor, cause the at least one processor to: monitor, at a gas oil separation plant (GOSP) facility that includes a high-pressure production trap (HPPT) apparatus, parameters associated with the GOSP facility: input the parameters to a trained machine learning model that outputs a minimum HPPT separation efficiency: determine a target HPPT separation efficiency based on the minimum HPPT separation efficiency; and adjust a demulsifier dosage being injected into the HPPT apparatus to separate dry oil at the target HPPT separation efficiency.

Embodiment 16: The least one non-transitory storage media of embodiment 15, wherein the parameters comprise at least one of an injection water rate, a wash water rate, a dehydrator voltage, a dehydrator current, HPPT oil or gas temperature, dry crude rate, demulsifier rate, dehydrator outlet water rate, steam consumption, or a dehydrator inlet temperature.

Embodiment 17: The least one non-transitory storage media of embodiments 15 or 16, wherein the target HPPT separation efficiency is continuously updated in real time in response to real-time process data associated with the GOSP.

Embodiment 18: The least one non-transitory storage media of embodiments 15-17, comprising determining a set point of an inlet temperature of a dehydrator using an artificial intelligence generated algorithm to optimize an overall energy consumption.

Embodiment 19: The least one non-transitory storage media of embodiments 15-18, wherein dehydrator transformer is a component of an electrostatic coalescer or a modulated AC/DC electrostatic coalescer device.

Embodiment 20: The least one non-transitory storage media of embodiments 15-19, wherein the demulsifier dosage is adjusted below a high output limit derived from a dehydrator voltage or current using artificial intelligence algorithms.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship. Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method: a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

Particular embodiments of the subject matter have been described. Other embodiments are within the scope of the following claims. For example, the actions recited in the claims can be performed in a different order and still achieve desirable results. As one example, some processes depicted in the accompanying figures do not necessarily require the particular order shown, or sequential order, to achieve desirable results.

What is claimed is:

1. A computer-implemented method, comprising:
monitoring, using at least one hardware processor, at a gas oil separation plant (GOSP) facility that includes a high-pressure production trap (HPPT) apparatus, parameters associated with the GOSP facility;
inputting, using the at least one hardware processor, the parameters to a trained machine learning model that outputs a minimum HPPT separation efficiency;
determining, using the at least one hardware processor, a target HPPT separation efficiency based on the minimum HPPT separation efficiency; and
adjusting, using the at least one hardware processor, a demulsifier dosage being injected into the HPPT apparatus to separate dry oil at the target HPPT separation efficiency.

2. The computer-implemented method of claim 1, wherein the parameters comprise at least one of an injection water rate, a wash water rate, a dehydrator voltage, a dehydrator current, HPPT oil or gas temperature, dry crude rate, demulsifier rate, dehydrator outlet water rate, steam consumption, or a dehydrator inlet temperature.

3. The computer-implemented method of claim 1, wherein the target HPPT separation efficiency is continuously updated in real time in response to real-time process data associated with the GOSP.

4. The computer-implemented method of claim 1, comprising determining a set point of an inlet temperature of a dehydrator using an artificial intelligence generated algorithm to optimize an overall energy consumption.

5. The computer-implemented method of claim 1, wherein dehydrator transformer is a component of an electrostatic coalescer or a modulated AC/DC electrostatic coalescer device.

6. The computer-implemented method of claim 1, wherein the demulsifier dosage is adjusted below a high output limit derived from a dehydrator voltage or current using artificial intelligence algorithms.

7. The computer-implemented method of claim 1, wherein adjusting the demulsifier dosage is based on a gas temperature indication at the HPPT apparatus using artificial intelligence algorithms.

8. A system, comprising:
at least one processor, and
at least one non-transitory storage media storing instructions that, when executed by the at least one processor, cause the at least one processor to:
monitor, at a gas oil separation plant (GOSP) facility that includes a high-pressure production trap (HPPT) apparatus, parameters associated with the GOSP facility:
input the parameters to a trained machine learning model that outputs a minimum HPPT separation efficiency:
determine a target HPPT separation efficiency based on the minimum HPPT separation efficiency; and
adjust a demulsifier dosage being injected into the HPPT apparatus to separate dry oil at the target HPPT separation efficiency.

9. The system of claim 8, wherein the parameters comprise at least one of an injection water rate, a wash water rate, a dehydrator voltage, a dehydrator current, HPPT oil or gas temperature, dry crude rate, demulsifier rate, dehydrator outlet water rate, steam consumption, or a dehydrator inlet temperature.

10. The system of claim 8, wherein the target HPPT separation efficiency is continuously updated in real time in response to real-time process data associated with the GOSP.

11. The system of claim 8, comprising determining a set point of an inlet temperature of a dehydrator using an artificial intelligence generated algorithm to optimize an overall energy consumption.

12. The system of claim 8, wherein dehydrator transformer is a component of an electrostatic coalescer or a modulated AC/DC electrostatic coalescer device.

13. The system of claim 8, wherein the demulsifier dosage is adjusted below a high output limit derived from a dehydrator voltage or current using artificial intelligence algorithms.

14. The system of claim 8, wherein adjusting the demulsifier dosage is based on a gas temperature indication at the HPPT apparatus using artificial intelligence algorithms.

15. At least one non-transitory storage media storing instructions that, when executed by at least one processor, cause the at least one processor to:
monitor, at a gas oil separation plant (GOSP) facility that includes a high-pressure production trap (HPPT) apparatus, parameters associated with the GOSP facility:
input the parameters to a trained machine learning model that outputs a minimum HPPT separation efficiency:
determine a target HPPT separation efficiency based on the minimum HPPT separation efficiency; and
adjust a demulsifier dosage being injected into the HPPT apparatus to separate dry oil at the target HPPT separation efficiency.

16. The least one non-transitory storage media of claim 15, wherein the parameters comprise at least one of an injection water rate, a wash water rate, a dehydrator voltage, a dehydrator current, HPPT oil or gas temperature, dry crude rate, demulsifier rate, dehydrator outlet water rate, steam consumption, or a dehydrator inlet temperature.

17. The least one non-transitory storage media of claim 15, wherein the target HPPT separation efficiency is continuously updated in real time in response to real-time process data associated with the GOSP.

18. The least one non-transitory storage media of claim 15, comprising determining a set point of an inlet temperature of a dehydrator using an artificial intelligence generated algorithm to optimize an overall energy consumption.

19. The least one non-transitory storage media of claim 15, wherein dehydrator transformer is a component of an electrostatic coalescer or a modulated AC/DC electrostatic coalescer device.

20. The least one non-transitory storage media of claim 15, wherein the demulsifier dosage is adjusted below a high output limit derived from a dehydrator voltage or current using artificial intelligence algorithms.
